(19) United States
(12) Patent Application Publication
(10) Pub. No.: US 2011/0148871 A1
(43) Pub. Date: Jun. 23, 2011

(54) APPARATUS AND METHOD FOR RENDERING WOVEN FABRIC MATERIAL BASED ON TYPE OF WEAVE

(75) Inventors: Sung-Soo KIM, Daejeon (KR); Joo-Haeng LEE, Daejeon (KR); Seung-Woo NAM, Daejeon (KR)

(73) Assignee: Electronics and Telecommunications Research Institute, Daejeon-city (KR)

(21) Appl. No.: 12/974,876

(22) Filed: Dec. 21, 2010

(30) Foreign Application Priority Data
Dec. 21, 2009 (KR) 10-2009-0128416

(51) Int. Cl. G06T 15/04; G06T 11/40

(52) U.S. Cl. 345/419; 345/582

(57) ABSTRACT

Disclosed herein are an apparatus and method for rendering woven fabric material based on a type of weave. The apparatus includes an input unit, a database (DB), a control unit, and a display unit. The input unit receives information about the type of weave and the material properties of the surface of a woven fabric object. The DB stores information about correlations between the types of weave and the material properties of the woven fabric objects and mathematical Bi-directional Reflectance Distribution Function (BRDF). The control unit searches the DB for rule data based on search condition information inputted from the input unit, and renders the woven fabric material. The display unit displays a rendered virtual woven fabric object in response to a control signal from the control unit.

### CROSS REFERENCE TO RELATED APPLICATION

This application claims the benefit of Korean Patent Application No. 10-2009-0128416 filed on Dec. 21, 2009 and entitled “Apparatus and Method for Fabric Objects Rendering,” which is hereby incorporated by reference in its entirety into this application.

### BACKGROUND OF THE INVENTION

1. Technical Field

The present invention relates generally to an apparatus and method for rendering woven fabric material based on the type of weave, which are used to render woven fabric material or the surface of clothes into a three-dimensional (3D) image, and, more particularly, to an apparatus and method for rendering woven fabric material based on the type of weave, which use a variety of types of mathematical Bi-directional Reflectance Distribution Functions (BRDFs) according to the types of weave so as to realistically represent woven fabric material, thereby more realistically representing virtual woven fabric material content.

2. Description of the Related Art

In general, 3D graphic data includes information about the geometry of objects located in a 3D space, and materials composing the objects located in the 3D space, information about the location and characteristics of a light source, and information about variations in the above information over time. The information about the geometry of objects includes information about the locations of 3D vertices of the objects and information about the connection between these vertices, and the information about the material composing the objects includes information about color and light reflectance of the surfaces. These types of information are represented in a structure which is easy to intuitively or logically understand so that users can easily create and modify 3D graphic data, and structure is commonly called a scene graph and which has an acyclic tree structure. A scene graph includes nodes which include information about the geometry and material of an object, and connection information which is configured to organize the nodes into a hierarchy by connecting them vertically. That is, nodes are the basic elements of a scene graph.

A part which defines the specific characteristics of such a node is a field. Recently, the performance of processors which render 3D graphic data has improved which has increased the desire to realistically represent natural objects in images of a higher quality. However, when representing the motion of a woven fabric structure, such as that of cloth, that is moving, the intrinsic internal characteristics of the woven fabric structure and externally applied physical forces, such as gravity, wind, acceleration and air resistance which occur as a result of actually occurring natural phenomena, must be taken into account. Furthermore, the influences upon and the motions that occur when the woven fabric structure collides with some other external object must also be taken into consideration.

Since methods for performing the above representations each use its own respective format, it is impossible to perform rendering and animation on 3D graphic models in a general-purpose manner Furthermore, authoring is very difficult because users perform creation while taking into account complex physical characteristics, and the compatibility between different types of rendering and authoring tools is not ensured because creation is performed using different formats.

The creation of the motion of woven fabric objects or cloth objects formed of existing fabric and the production of the results in the form of 3D images are being actively carried out in a variety of fields. However, these methods focus on rendering the results of closely observing woven fabric material. Furthermore, these methods are based on a technology using a Bi-directional Texture Function (BTF) configured to store the texture using the angle and reception viewing angle of light incident using special measuring equipment with respect to real world woven fabric material. This technology has the disadvantages of requiring a massive storage space and incurring large amounts of compression and loss when it is used to actually perform rendering.

Although current simulation technology is able to create very realistic fabric even in a real-time environment, a model for woven fabric material and the surface reflection of fabric still cannot be performed to satisfaction.

An existing graphic library (OpenGL or DirectX) Gouraud shading technique for performing real-time rendering has the problem of realistically representing the materials of woven fabric objects. Although another method can apply a mathematical reflection model, such as a Phong model, using a graphics processing unit (GPU), this method also has the problem of it being difficult for it to represent woven fabric material and imparting a realistic feeling.

In order to overcome this problem, the modeling of woven fabric material or rendering is performed using existing 3D modeling software (for example, Maya, or 3DMax) or clothing design-dedicated software (for example, OptiTeX) depending on the manual work of a designer. However, not only can such work be done by a skilled expert but it also requires a large amount of time. Nevertheless, limitations still exist on the realistic representation of the material of woven fabric objects.

### SUMMARY OF THE INVENTION

Accordingly, the present invention has been made keeping in mind the above problems occurring in the prior art, and an object of the present invention is to provide an apparatus and method for rendering woven fabric material based on the type of weave, which is capable of realistically representing a woven fabric object corresponding to search conditions required by a user.

Another object of the present invention is to mitigate the problem which is caused by the massive amount of data generated by measuring equipment in relation to woven fabric.

Still another object of the present invention is to provide an apparatus and method for rendering woven fabric material based on the type of weave, which are capable of creating texture unique to a woven fabric material.

Still another object of the present invention is to provide an apparatus and method for rendering woven fabric material based on the type of weave, which are suitable for designers who have no detailed knowledge of computer graphics.

Still another object of the present invention is to provide an apparatus and method for rendering woven fabric material based on the type of weave, which take into consideration the gaps of a surface and the shadows of yarn, which the weaving of the woven fabric can bring about.

In order to accomplish the above object, the present invention provides an apparatus for rendering woven fabric material based on a type of weave, including an input unit for receiving information about the types of weave and the material properties of the surface of a woven fabric objects; a database (DB) for storing information about correlations between mathematical Bi-directional Reflectance Distribution Functions (BRDFs) based on the types of weave and the material properties of woven fabric objects; a control unit for searching the DB for rule data based on search condition information inputted from the input unit to perform rendering for a woven fabric material; and a display unit for displaying a rendered virtual woven fabric object in response to a control signal from the control unit.

The DB may include at least one of a weave type DB, a material property DB, and a representation rule DB regarding the correlations between mathematical BRDFs based on types of weave and material properties of woven fabric objects.

The control unit may extract a mathematical Bi-directional Reflectance Distribution Function (BRDF) model and application parameters from the representation rule DB to apply these to the rendering of the woven fabric material.

The rendering combines reflection of an anisotropic microfacet model with a Lambertian reflection model.

The search condition information may include at least one of the direction and sequence of the weave of the woven fabric object and the material properties of the woven fabric object for each layer.

Additionally, in order to accomplish the above object, the present invention provides a method of rendering woven fabric material based on a type of weave, including receiving search condition information related to rendering of woven fabric material from a user; searching for rule data regarding the type of weave and the material properties of the surface of a woven fabric object in response to the search condition information, input by the user, using established rule DBs; rendering the woven fabric material using the searched rule data; and producing a finally rendered virtual woven fabric object image as a result.

The method may further include, before the receiving, establishing classification DBs regarding types of weave and material properties of surfaces based on types of woven fabric objects.

The method may further include, before the receiving, establishing a representation rule DB regarding correlations between mathematical BRDF based on types of weave and material properties of woven fabric objects.

The method may further include, before the rendering, extracting a mathematical BRDF model and application parameters from the representation rule DB; wherein the rendering renders the woven fabric material using the mathematical BRDF model and the application parameters.

The rendering may combines reflection of an anisotropic microfacet model with a Lambertian reflection model.

The search condition information may include at least one of the direction and sequence of the weave of the woven fabric object and the material properties of the woven fabric object for each layer.

Additionally, in order to accomplish the above object, the present invention provides a method of rendering woven fabric material based on a type of weave, including rendering the woven fabric material into a 3D image using a BRDF which is stored in a DB and corresponds to a type of weave and properties of surface material based on a type of woven fabric material desired by a user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram schematically showing the configuration of an apparatus for rendering woven fabric material based on type of weave according to the present invention;

FIG. 2 is a flowchart showing a process of determining and applying a BRDF;

FIG. 3 is a diagram showing an example of a weaving pattern for representing anisotropy using the weaving pattern of the present invention; and

FIGS. 4A to 4D are photographs showing an example of the comparison between rendering using an existing GPU technique and rendering using surface application models in connection with the woven fabric material rendering according to the present invention.

### DESCRIPTION OF THE PREFERRED EMBODIMENTS

Reference now should be made to the drawings, in which the same reference numerals are used throughout the different drawings to designate the same or similar components.

An apparatus and method for rendering woven fabric material based on the type of weave according to the present invention will be described in detail below with reference to the accompanying drawings.

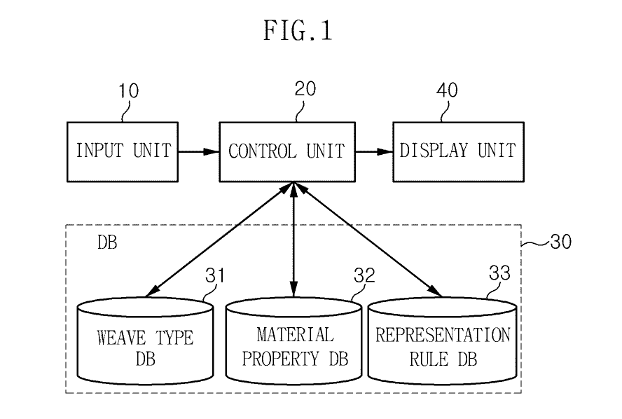

FIG. 1 is a block diagram schematically showing the configuration of the apparatus for rendering woven fabric material based on the type of weave according to the present invention.

Referring to FIG. 1, the apparatus for rendering woven fabric material based on the type of weave according to the present invention includes an input unit 10, such as a keyboard or a mouse, for receiving information about the desired type of weave and properties of the surface material of a woven fabric object from a designer, a database (DB) 30 including a weave type DB 31, a material property DB 32 and a representation rule DB 33 for storing data about correlations between mathematical BRDFs, a control unit 20 for searching the DBs 31, 32 and 33 for rule data based on information inputted from the input unit 10 and rendering woven fabric material, and a display unit 40 for displaying a rendered virtual woven fabric object in response to a control signal from the control unit 20.

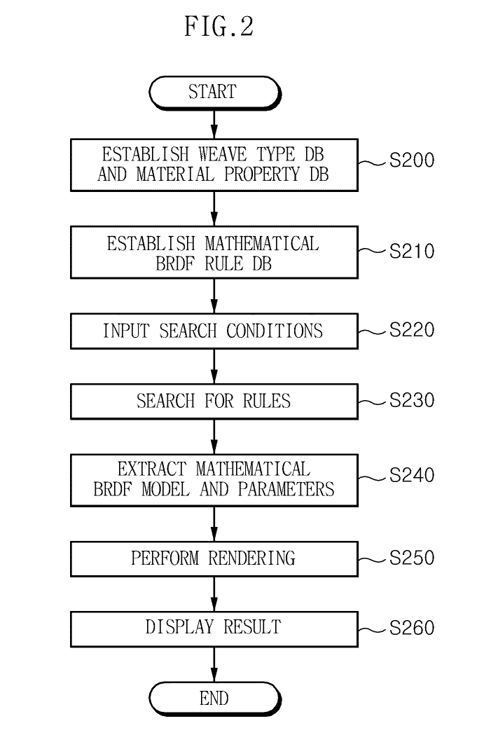

FIG. 2 is a flowchart showing a process of determining and applying a BRDF.

Referring to FIG. 2, DBs regarding the types of weave and material properties are established. In the present invention, in order to classify woven fabric objects according to the material properties, classification is performed based on fabric, which is a representative example of woven fabric objects.

An example of representative classification includes cotton fabric, linen fabric, woolen fabric, silk fabric, chemical fiber fabric, synthetic fiber fabric including nylon, polyester, acryl and polyurethane fabric, and other fabric including non-woven fabric, lace and synthetic leather.

Although a basic type of weave uses the simple repetitive pattern of warps and woofs, extension may be made by storing a variety of types of weave in the DB 30 at step S200.

A mathematical BRDF DB based on the types of weave and material properties is established at step S210.

After the DBs 31, 32 and 33 required for rendering have been established, search condition information is received from a user at step S220. Search conditions may include the direction and sequence of a weave of the woven fabric object and the material properties of the woven fabric object for each layer.

The established DBs 31, 32 and 33 are searched for rules related to the type of weave and properties of a surface material of a fabric object desired by a user at step S230.

Furthermore, a mathematical BRDF model and parameters are extracted from the representation rule DB 33 at step S240

Thereafter, the rendering of the woven fabric material is performed using the rule data, searched at steps S220 and S230, at step S250.

In the present invention, the rendering step S250 is based on a microfacet model so as to represent the surface material of the woven fabric object. However, a Lambertian model, a Blinn-Phong model, a Ward model, a He model or the like may be used depending on the properties of the surface material of a woven fabric.

For example, in the example of a warp/woof weaving pattern having the reflective characteristics of an anisotropic surface, rendering may be performed using the following method. The reflective characteristics of the microfacet model are determined depending on a probability distribution which the normal vectors of patch surfaces have.

Here, in order to represent the appearance of the anisotropic surface of the woven fabric material, a method proposed by Ashikhmin and Shirley is used. In this case, a microfacet distribution function may be expressed by the following Equation 1:

D(wₕ)=\sqrt{(eₓ+1)(e_{y}+1)}(wₕ·n)^{e}^{ₓ} ^{cos}^{²} ^{ø+e}^{_{y}} ^{sin}^{²} ^{ø} (1)

where eₓ and e_{y} enable the characteristics of microfacets to be represented along the two-dimensional (2D) axes of a surface.

In general, the fabric which forms clothes is a woven object, and is most generally formed by alternately crossing warps and woofs. The reflection anisotropy of the surface of a woven fabric object is chiefly dependent on the direction in which the yarn goes across the reflective surface.

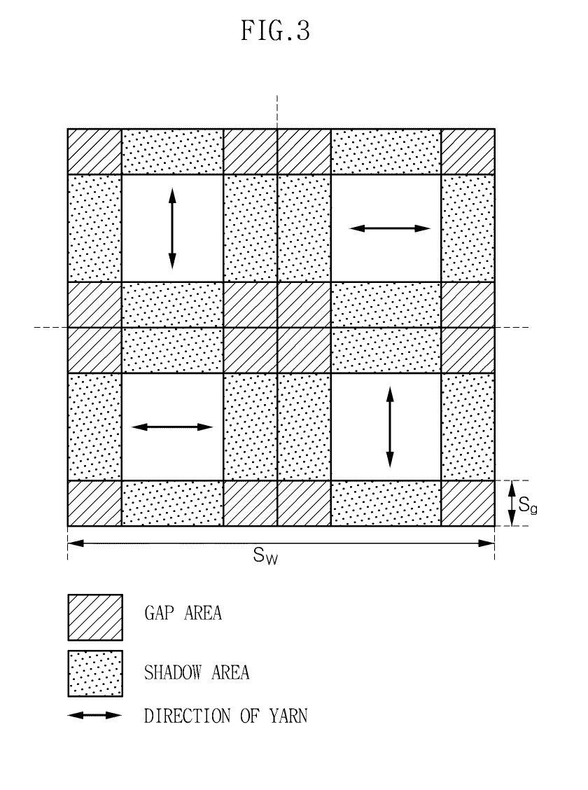

Accordingly, the model proposed by the present invention is a model in which the anisotropy of a surface varies depending on the size of a weaving pattern. When a weaving pattern is greatly enlarged, the weaving pattern can be simplified, as shown in FIG. 3.

In FIG. 3, the size of a single weaving pattern is denoted by S_{w}, and the size of gap between two strands of yarn is denoted by S_{g}.

In FIG. 3, the hatched areas denote gaps through which yarn does not pass, and the dotted areas denote areas in which shadow is formed by weaving. The arrows denote the directions in which the yarn goes, and reflective characteristics vary depending on the directions.

The present invention simply uses a model for exchanging the values of eₓ and e_{y} of Equation 1 along the above directions. In this case, the direction of the yarn may be expressed by the following Equation 2:

$$δ = \frac{( u - {w}_{s} - {w}_{s} [ \frac{u}{{w}_{s}} ] ) ( v - {w}_{s} - {w}_{s} [ \frac{v}{{w}_{s}} ] )}{2 {w}_{s}} \qquad ( 2 )$$

where u and v are the texture coordinates of the surface. The direction of yarn is determined depending on these texture coordinates. If the value obtained by Equation 2 is negative, the direction of yarn is set as a vertical direction; if the value is positive, the direction of yarn is set as a lateral direction.

The rendering method proposed by the present invention is based on the combination of the reflection of an anisotropic microfacet model and a Lambertian reflection model. The Lambertian model performs adjustment such that light is not reflected in the gaps between strands of yarn and shadow areas are darkened, while the anisotropic microfacet model adjusts the directions of the normal vectors of microfacets according to the directions in which the strands of yarn go.

Finally, a rendered image is displayed on the display unit 40 at step S260.

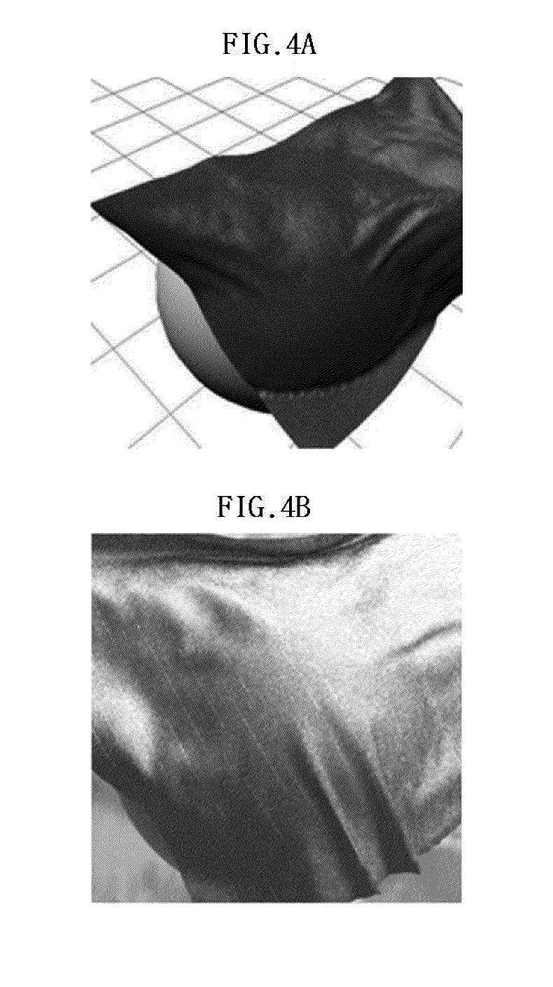

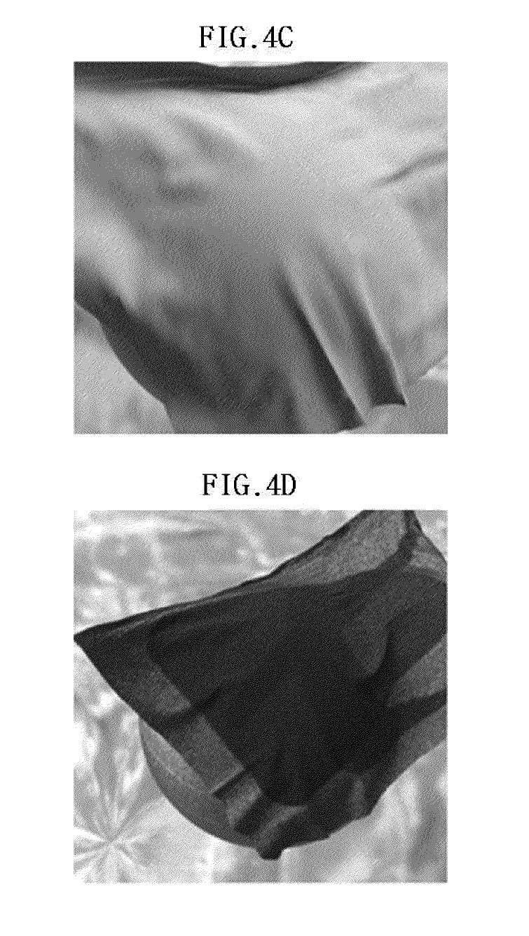

Meanwhile, FIGS. 4A to 4D are photographs showing an example of the comparison between rendering using a conventional GPU technique and rendering using surface application models in connection with the apparatus for rendering woven fabric material based on the type of weave according to the present invention.

FIG. 4A shows the result of rendering using a GPU, FIG. 4B shows the result of rendering using a Blinn-Phong model, FIG. 4C shows a result based on a measured BRDF value, and FIG. 4D shows the 3D content of woven fabric material displayed using the display unit when the present invention has been applied thereto.

The apparatus and method for rendering woven fabric material based on the type of weave are expected to achieve the following advantages:

First, the apparatus and method have the advantage of implementing an anisotropy that varies, which is generated by the weaving pattern of a woven fabric object, using a microfacet model.

Second, the apparatus and method have the advantage of providing a rendering model in which the gaps of a surface and the shadows of yarn, which result from the weaving of woven fabric, are taken into consideration.

Third, the apparatus and method have the advantage of eliminating the geometric modeling of woven fabric material and the use of a large amount of bi-directional woven fabric function.

Fourth, the apparatus and method have the advantage of reducing the rendering time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for rendering woven fabric material based on a type of weave, comprising:
an input unit for receiving information about the types of weave and material properties of a surface of woven fabric objects;
a database (DB) for storing information about correlations between mathematical Bi-directional Reflectance Distribution Functions (BRDFs) based on types of weave and material properties of woven fabric objects;
a control unit for searching the DB for rule data based on search condition information inputted from the input unit to perform rendering for a woven fabric material; and
a display unit for displaying a rendered virtual woven fabric object in response to a control signal from the control unit.

2. The apparatus as set forth in claim 1, wherein the DB comprises at least one of a weave type DB, a material property DB, and a representation rule DB regarding the correlations between mathematical BRDFs based on types of weave and material properties of woven fabric objects.

3. The apparatus as set forth in claim 1, wherein the control unit extracts a mathematical Bi-directional Reflectance Distribution Function (BRDF) model and application parameters from the representation rule DB to apply these to the rendering of the woven fabric material.

4. The apparatus as set forth in claim 1, wherein the rendering combines reflection of an anisotropic microfacet model with a Lambertian reflection model.

5. The apparatus as set forth in claim 1, wherein the search condition information comprises at least one of a direction and sequence of a weave of the woven fabric object and material properties of the woven fabric object for each layer.

6. A method of rendering woven fabric material based on a type of weave, comprising:
receiving search condition information related to rendering of woven fabric material from a user;
searching for rule data regarding a type of weave and material properties of a surface of a woven fabric object in response to the search condition information, input by the user, using established rule DBs;
rendering the woven fabric material using the searched rule data; and
producing a finally rendered virtual woven fabric object image as a result.

7. The method as set forth in claim 6, further comprising, before the receiving, establishing classification DBs regarding types of weave and material properties of surfaces based on types of woven fabric objects.

8. The method as set forth in claim 6, further comprising, before the receiving, establishing a representation rule DB regarding correlations between mathematical BRDF based on types of weave and material properties of woven fabric objects.

9. The method as set forth in claim 8, further comprising, before the rendering, extracting a mathematical BRDF model and application parameters from the representation rule DB;
wherein the rendering renders the woven fabric material using the mathematical BRDF model and the application parameters.

10. The method as set forth in claim 6, wherein the rendering combines reflection of an anisotropic microfacet model with a Lambertian reflection model.

11. The method as set forth in claim 6, wherein the search condition information comprises at least one of a direction and sequence of a weave of the woven fabric object and material properties of the woven fabric object for each layer.

12. A method of rendering woven fabric material based on a type of weave, comprising rendering the woven fabric material into a three-dimensional (3D) image using a BRDF which is stored in a DB and corresponds to a type of weave and properties of surface material based on a type of woven fabric material desired by a user.
